(19) United States
(12) Patent Application Publication
(10) Pub. No.: US 2020/0380511 A1
(43) Pub. Date: Dec. 3, 2020

(54) COMPUTER-IMPLEMENTED SYSTEM AND METHOD FOR INITIATING AND FULFILLING E-COMMERCE TRANSACTIONS FROM COLLABORATION SERVICES

(71) Applicant: Lisa Katherine Hull, Arroyo Grande, CA (US)

(72) Inventor: Lisa Katherine Hull, Arroyo Grande, CA (US)

(21) Appl. No.: 16/884,288

(22) Filed: May 27, 2020

Related U.S. Application Data
(60) Provisional application No. 62/854,119, filed on May 29, 2019.

(51) Int. Cl. G06Q 20/40; G06Q 20/12; G06Q 20/32; G06Q 20/38; G06Q 20/10

(52) U.S. Cl. CPC G06Q 20/40; G06Q 20/12; G06Q 20/10; G06Q 20/382; G06Q 20/385; G06Q 20/322

(57) ABSTRACT

A computer-implemented system and method for initiating and fulfilling e-commerce transactions from collaboration services is described.

### PRIORITY PATENT APPLICATION

This non-provisional patent application draws priority from U.S. provisional patent application Ser. No. 62/854,119; filed May 29, 2019. This present non-provisional patent application draws priority from the referenced patent application. The entire disclosure of the referenced patent application is considered part of the disclosure of the present application and is hereby incorporated by reference herein in its entirety.

### BACKGROUND

### Copyright

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2019-2020, Lisa Katherine Hull. All Rights Reserved.

### TECHNICAL FIELD

Embodiments relate to the field of networking and chat/collaboration services, e-commerce and language processing.

### RELATED ART

It is ironic that as the Internet and World Wide Web technologies have grown substantially over the past 25 years, the user interfaces are, in fact, becoming simpler. Instead of more complex graphics user interfaces, simple text interfaces such as SMS (text message) and chat (Instant Message/Direct Message) continue to gain in popularity. One of the reasons this is the case is because of the mobile platform having limited screen real estate, but simplicity is likely the primary factor. As well, the mobile client taking audio input and converting it to text has facilitated such non-graphical user interface input methods.

Chat services have moved from “bulletin board systems” and AOL Instant Messaging to much more robust services such as Microsoft Teams, Slack, and Facebook chat. The popularity of the interface has provided Microsoft and Slack the ability to provide revenue-based services based on chat to large enterprise/commercial organizations.

Companies offering chat/collaboration services such as Microsoft (“Teams”) or Slack make Application Programming Interfaces available (APIs). These APIs augment the ecosystem of the provider by extending the capabilities in virtually limitless ways.

Similarly, e-commerce popularity continues to grow, with malls and retail closures continuing at a brisk rate as a result. The ability to have a limitless supply of products delivered often within 24 hours has proven a value to the bulk of consumers in the early 21st century.

US Patent Application 20190130475 references the concept of “Conversation as a Platform” to dynamically generate payment agreements that enable asynchronous actions to be performed for e-commerce transactions, leveraging machine-based chat.

US Patent Application 20190130499 references an application and method for social media e-commerce interaction by selecting users associated with a chat functionality.

However, these patent disclosures do not provide a system or method for initiating and processing e-commerce transactions from chat-based or collaboration services. Thus, a computer-implemented system and method for initiating e-commerce transactions from chat services is needed and described.

### BRIEF DESCRIPTION OF THE DRAWINGS

Embodiments are illustrated by way of example and not limitation in the figures of the accompanying drawings, in which:

FIG. 1 (Flowchart 50) describes the logic for parsing incoming commands.

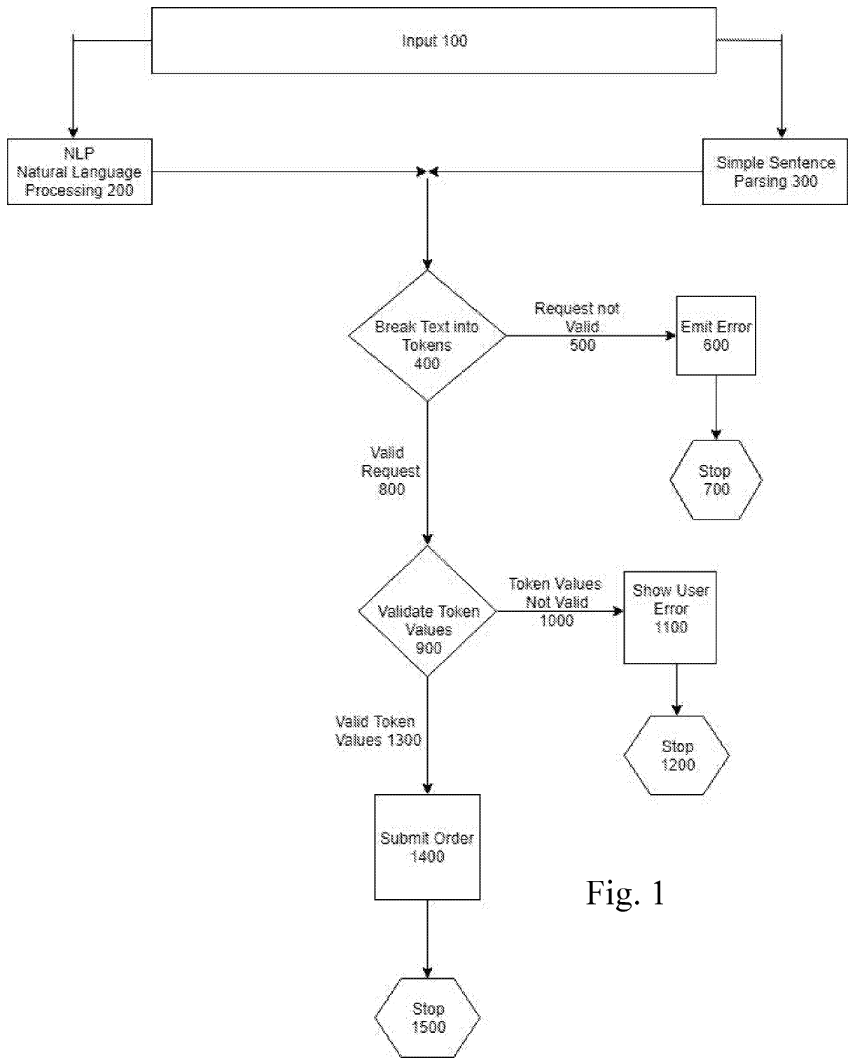

FIG. 2 (Diagram 50) is a breakdown of the major processing components.

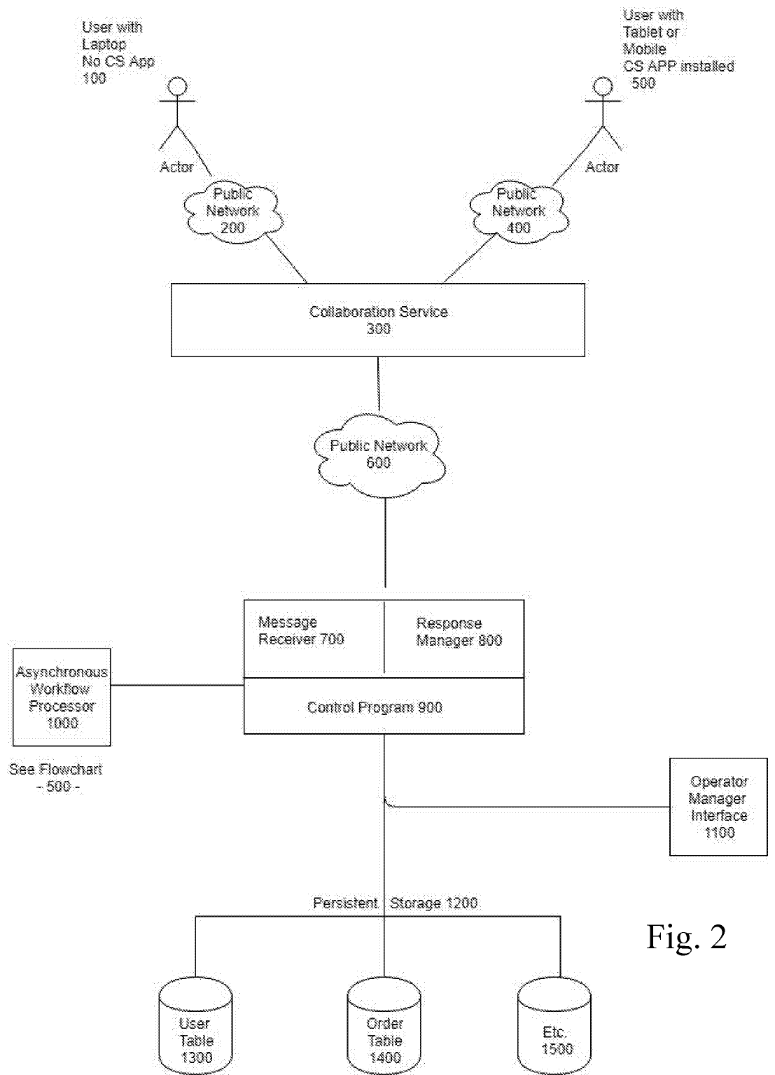

FIG. 3 (Diagram 100) identifies the components of simple sentence parsing.

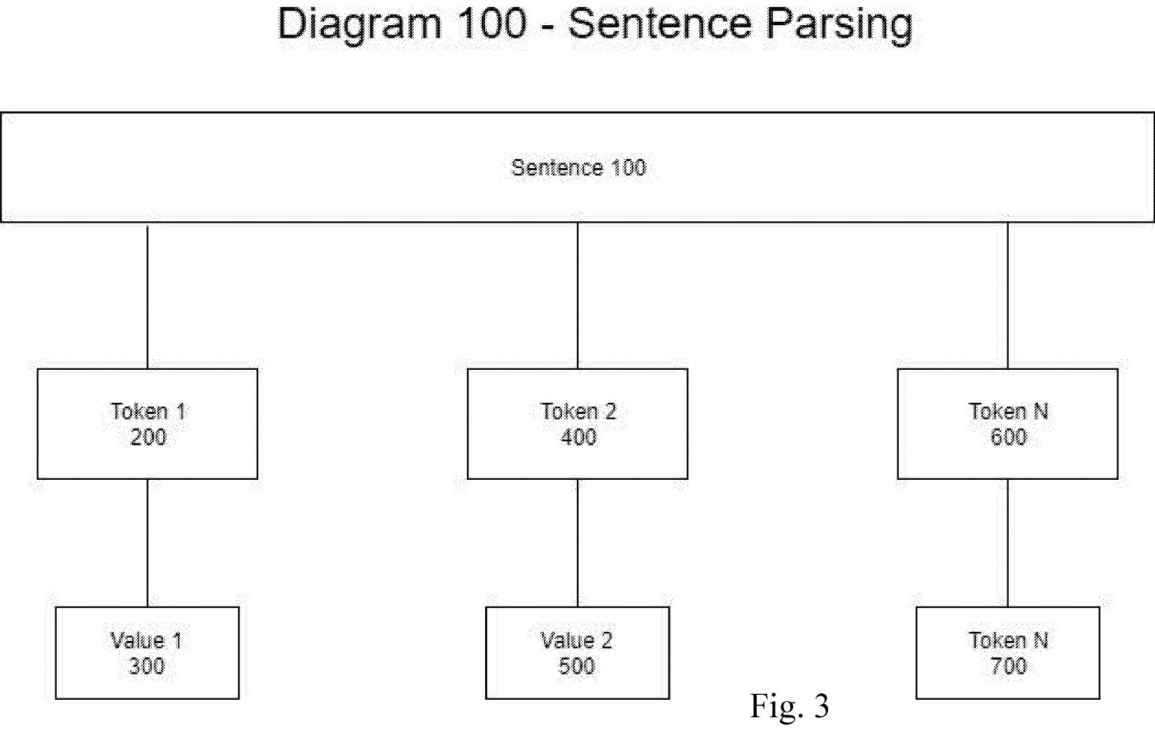

FIG. 4 (Flowchart 100) describes the overall workflow associated with order processing.

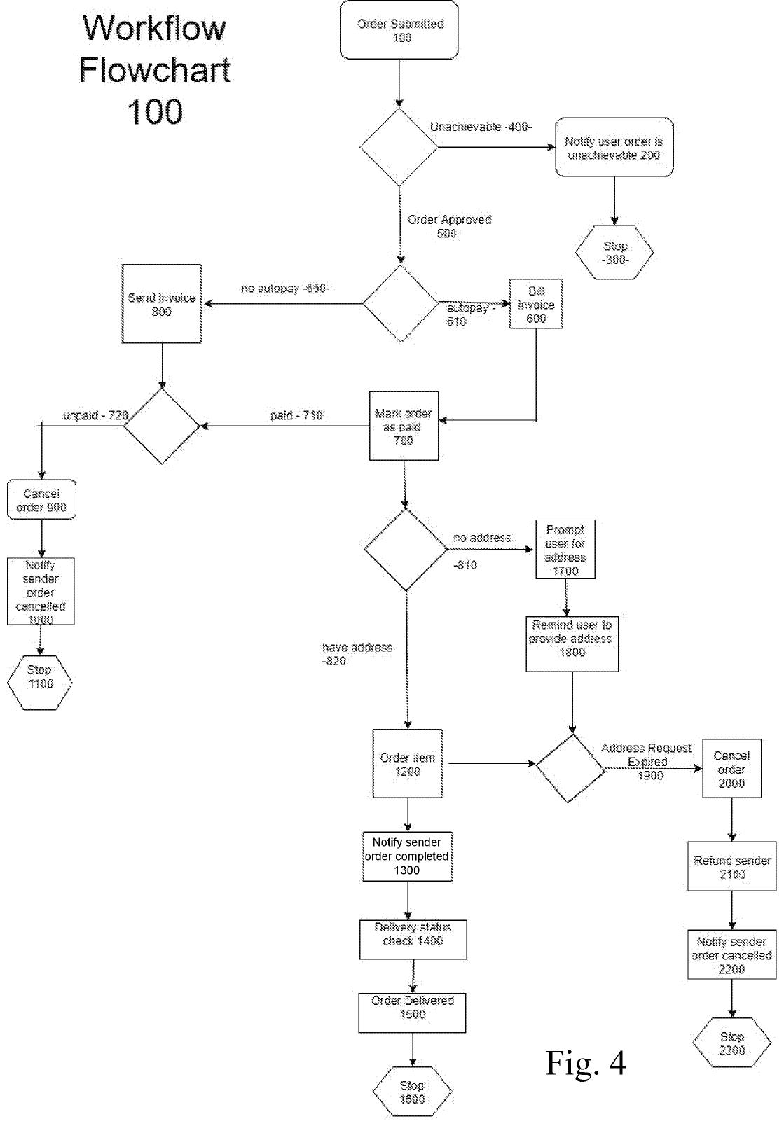

FIG. 5 (Diagram 300) is block diagram of an embodiment of a Command Processor.

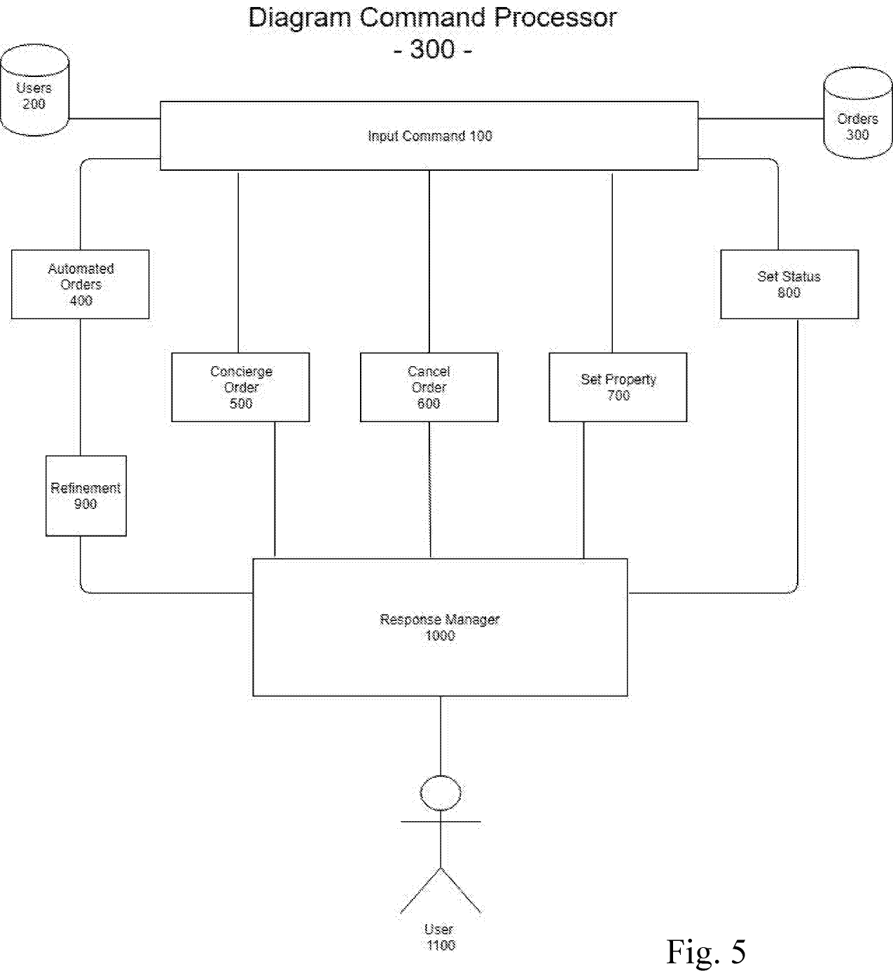

FIG. 6 (Flowchart 500) describe the asynchronous workflow that occurs continually in the background (“cron” processing).

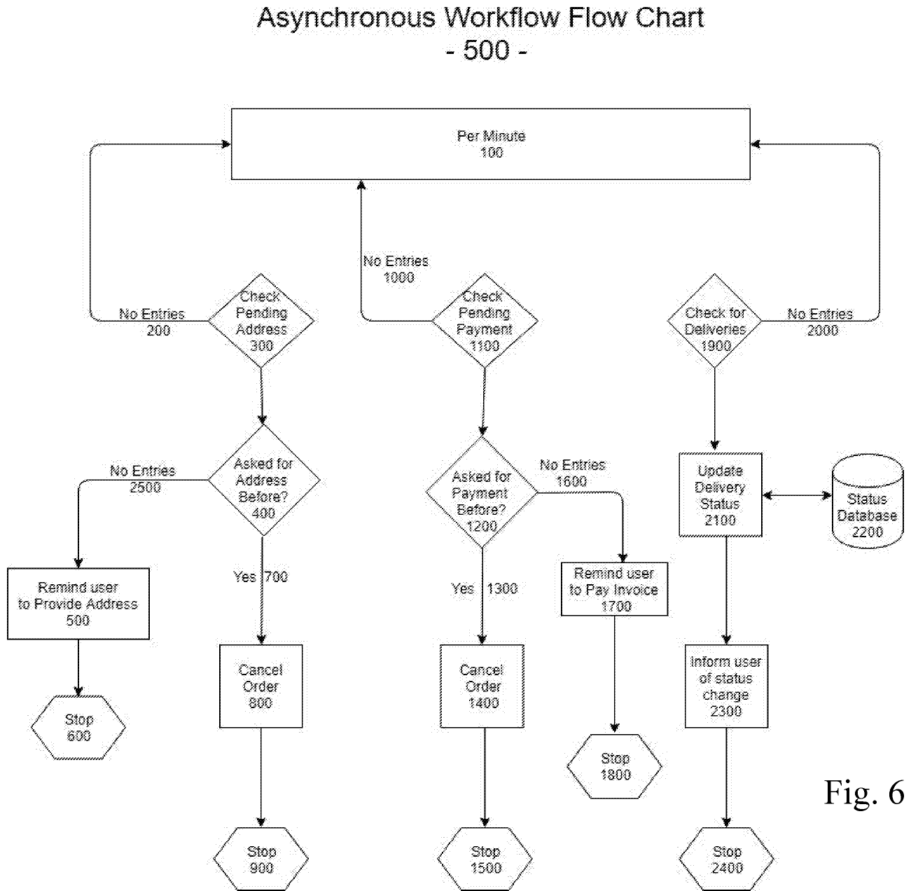

FIG. 7 (Flowchart 600) depicts the Order Processing Workflow.

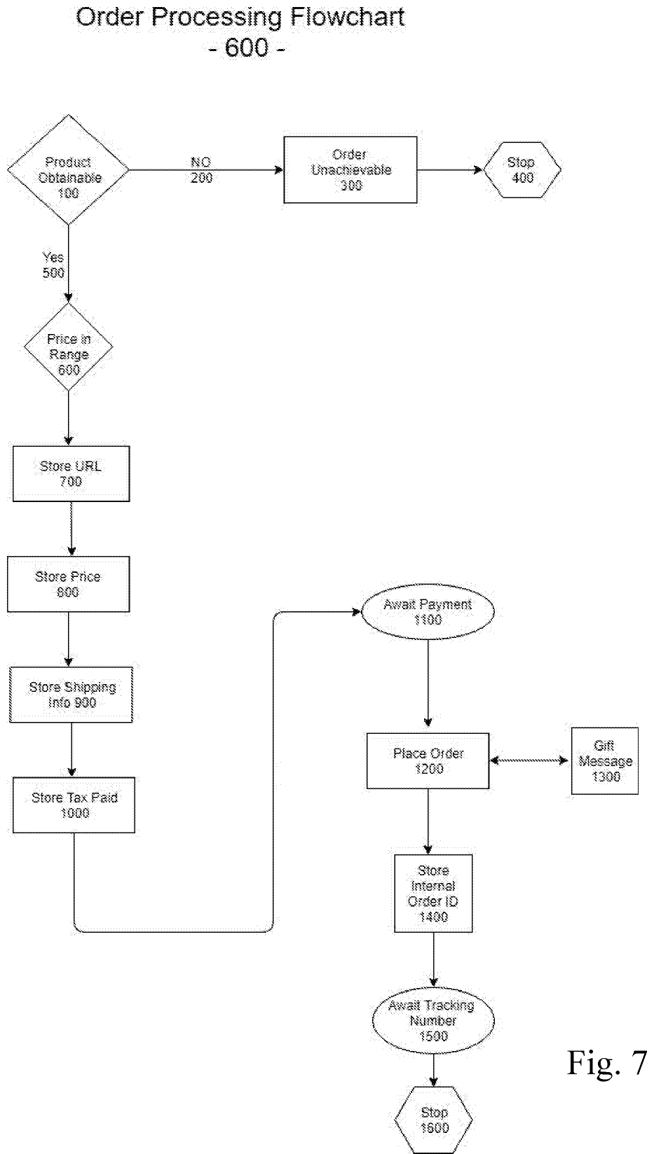

### DETAILED DESCRIPTION

The initial flow begins with a user typing a command into a command-line based system of the Collaboration Service (CS). One embodiment of the command-line based system is a chat service either running in a web browser installed on a desktop, tablet or laptop computer or the chat service running as an “app” on a mobile client (cell phone). See Flowchart 50 and Diagram 100 in reference to parsing the input command.

The intent of the text is to perform an e-commerce action, which is typically to purchase something or pay for a service of some kind, and to make the request as simple as possible, with the intent of maximizing the automation as much as possible. The service can be external to the chat/collaboration system or within it. For example, in one embodiment, a user may request to make a video montage from uploaded images for a fee (or perhaps for free, or in another embodiment a “freemium” model where a subset of use is free and other features or use is for a fee including subscription option). This is an e-commerce transaction. In another embodiment a user may request a concierge service to purchase something on their behalf using their Internet-at-large.

Another primary novel benefit, in one embodiment is the, savings in time, logistics and “social awkwardness” by the requestor/originator not needing to ask the recipient for their shipping address. If one CS team member wants to send something to another team member, they would typically have to ask for their shipping address. They addressee may or may not want to provide their address to the person asking. Also, that requires more time and logistics even if the recipient is cooperative. By offloading the address acquisition process to the invention, the originator has one fewer steps to deal with and avoids awkwardness with the recipient. This is described in more detail below with regards to maintaining the state of the workflow.

The originator makes a request through the CS. The request may be completely filled in an automated fashion (e.g. a request for a custom printed shirt using images from with the CS) or the request may use a human as an intermediary/proxy to find the item and place the order on behalf of the requestor (typically using the CS's account and specifying the recipient as the gift recipient), in one embodiment.

Further the request for any e-commerce obtainable item may be completely automated if the destination e-commerce vendor supports automation. At the time of this writing, Amazon and Walmart do not support such automated ordering, but other services do and other services in the future may support such API's that allow integration and completely automated ordering. For example, if the requestor specifies a barcode or UPC code or any other uniquely identifying numbers, and an e-commerce retailer supports, through APIs, ordering products based on such unique identifiers, then the request fulfillment can be completely automated.

The user's (requestor's) command must be parsed to determine what the user is requesting to do. Various algorithms exist to analyze written text to determine the intent of what was typed. In one embodiment, “Natural Language Processing” (NLP) algorithms are used to allow the user to enter “free format” text in their language-of-choice. These are sophisticated and work well much of the time but can be complex and do not work well with all languages. However, in one embodiment NLP algorithms are used to deconstruct the input to determine its intent. In another embodiment the source language is detected either automatically (from the CS) or semantically and NLP or parsing rules are loaded that language-specific.

In another embodiment a much simpler method is used to break the user input into relevant phrases. In one embodiment using the English language (but applies for all languages), various tokens (“terms”) split the entered text into its logical parts. For example, if a user were to type “buy 3 cans of yellow tennis balls and send them to john smith at 123 e main st. in nevada city, california 95959” the tokens may be constructed as “buy”<something> “and send”<something> “to”<someone> “in”<some location>. The parsing of the tokens may or may not be order sensitive, in that the “and send” could logically come first with the “buy” coming afterwards. In this embodiment the intent is to break the entered text into its logical components to understand the request of the user. In an embodiment using NLP the end-result is the same, but is arrived by using complex algorithms (taking as input free format language text) vs. a tokenized input with a specified syntax. Ambiguity must be resolved using the simple parser in the case that the user enters the “by” token in multiple places, e.g. “buy a 20×24 reprint of any artwork by van gogh and send to john smith by his birthday.” The simple parser can easily detect this situation through determination that the tokens after the second “by” represent a date or holiday or day mnemonic vs. the first instance.

Note that input can originally come via voice, which is converted to text via voice-to-text conversion software that comes with a mobile device or a user's desktop computer/laptop. This is transparent to the parsing algorithm.

The request entered may be, as mentioned before, in one embodiment, to initiate an e-commerce transaction for a digital service (e.g. video montage from uploaded images) or it could be a proxied request to a concierge service, in yet another embodiment. Yet another embodiment could be a request and payment for a physical good of some form, but that does not require any human (concierge) intervention, such as using an image uploaded to the collaboration service that ultimately is printed on a t-shirt all implemented through software requests eventually “driving” the printing equipment (humans may load a t-shirt onto a press but are not involved in proxying the transaction per se).

In the simple (non-NLP) case, the expression is parsed and broken into its constituent parts based on the elements of the input. The logical components are analyzed to determine if all required elements exist. For example, if the request is to purchase something, there must be a lexical element that describes what should be purchased. In one embodiment, the lexical components can include an item, a recipient, a maximum price. In another embodiment, a repeating frequency may be included (e.g. “every 2 weeks”), a specific date (“on 12 Jan. 2020”), on a logical date (“on Bob's birthday”) a holiday (“On Christmas”), etc. See Diagram 100.

If a required element is not present (e.g. no recipient) then an error must be displayed to the user who entered the request. The response can use the native response/request API of the chat service. All or single errors may be presented in case of greater than 1 error. Errors must also detect if a lexical component is present but its value is invalid, for example, a repeating date is supplied but the date is in the past, or of an unparseable format. See Parsing Flowchart 50.

In one embodiment recipient validation is done against the list of users associated with the chat service. In another embodiment the address, if supplied, of the recipient is validated against valid addresses. In another embodiment, the recipients (there can be more than one) could be listed by first name or display name or username, etc. The chat system API must be used to find the closest match given the variety of input names that could be supplied with such systems.

The next step is to determine if a human concierge must be applied to complete the transaction or if it can be automated. See Flowchart 100, step 100. The request (or “order”) is received by the system as the user's command is relayed to the entity responsible for command processing. In one embodiment this is called the Command Processor (CP). The CP is responsible for determining, based on the validated input parsing, what logical processing steps should subsequently occur. In one embodiment a valid, but partially completed command, can be responded to with suggestions for properly completing the task.

The CP determines the command properties (see Diagram 300). A command may be initiating an order or checking on prior order status. A command may be canceling a prior request. A command may be to set a specific property associated with payment or ordering. These are discussed below.

In the case the CP determines the request is an incoming order, it must determine if the order is for an automated item or a concierge item. If for an automated item, the relevant software modules are loaded and executed that are required to place the automated this order. This might require additional information from the user. In one embodiment, the user may request an automated order of an image to be printed on a t-shirt. The user will need to specify what type oft-shirt, the color, the size, the image to use, etc. The CP must then iterate through a series of questions and refinement to the user to finalize the input for the automated order. This interface can be through a graphical user interface, even if the original request was via a command line, or in yet another embodiment it can be through a series of iterative questions and answers via the command line (see “Response Manager” in Diagram 300).

Alternatively, if the request is for a UPC or barcode or similar unique identifier, and a relationship exists with an e-commerce supplier that supports automated offerings via an API, then the request can be completely automated.

Once the required information is obtained for the automated order, it can be placed with associated order ID's and properties stores in the order database.

If the order is not automated, it is a concierge order and must be assigned to an operator. In one embodiment the operator is notified via an audible sound that an order is ready for service. Other embodiments may use text messaging, phone calls, emails or flashing text/buttons to indicate an order is ready for concierge processing. The intent is for an operator to know that an order needs their attention.

In one embodiment a “lock” is placed on the record while one operator is working on it to avoid multiple operators perform the same task on the same order. The lock can be exclusive where no other operator can view the order or can be passive and merely a warning, in another embodiment.

It is the responsibility of the concierge operator (CO) to determine the request that was made by the user is actually viable. See “CONCIERAGE OPERATOR” below. It must exist, be obtainable and meet any other requirements (such as within a certain price range). See steps 400 and 500 in Flowchart 100. If the order is not achievable it is rejected and canceled and the user notified.

If the CP determines the command is to cancel an order it verifies such an order exists for the user and cancels it in the order database with the following additional logic. It must determine if the order has already been paid but not fulfilled and if so it must issue a credit/refund back to the user. If the credit has already been issued it need do nothing other than inform the user of such a condition. If the user has been invoiced with to-be-auto-billed invoice, then the invoice must be canceled/voided, but no credit actually created.

If the CP determines the user is request setting a property, such as name, address, etc. it will simply update the user database with such information.

In one embodiment, the CP allows the user to avoid having to enter credit card information each time. In one embodiment this is done by using auto-approved invoices that are billed after some period of time (e.g. 1 hour). In one embodiment the user can disable or enable such a capability. In one embodiment of the “auto approve” capability, there is a password associated such that it must be entered after each order to avoid nefarious individuals placing orders using someone else's account. In one embodiment an email is sent to the user if this setting changed.

If the CP determines the request is for order status, it retrieves the user's order status (both as recipient and originator) and formats appropriate for the user to view.

All interaction between the CP and user is through the Response Manager (RM). The RM may emit and format input and output in a variety of ways depending on the underlying capabilities of the Collaboration “Chat” Service. In one embodiment it will be iterative question/answer via command line. In another embodiment it will be through dialog boxes. In another embodiment it will be through proprietary UI elements (e.g. Slack “Block Kit”).

The RM must be aware of the Transport Method (TM) to send the resulting content. The TM maybe a “response” to a request and contain a value that identifies the command from the user that is being responded to by the RM. The TM may also, instead, in case the time window for a response has expired, be a target userID for whom the RM has authority to send a message at any time.

For example, in one embodiment, the CP determines 2 days have gone by without receiving payment. The Asynchronous Processor (see Flowchart 500) must inform the originator that the request be at risk of expiration and cancellation. The TM cannot use a response ID from the CS as it is likely to have expired and hence must use a direct message to the userID.

State management is key to the CP knowing what can and cannot be done at any given phase of ordering, processing and fulfillment. In one embodiment, the following states exist. They may be implemented as a classic state machine or use any other analogous logic and control flow.

Submitted: The order has been validated and submitted. See Step 100 in Flowchart 100.

Assigned: The order has been submitted and has been assigned to an Operator for review (relevant for Concierge orders only). This occurs between step 100 and step 500 in Flowchart 100.

Unachievable: The order was deemed unachievable and has been canceled. See step 400 in Flowchart 100.

Pending response: The order needs refinement and the originator has been contacted for additional information.

Pending payment: The order has been approved and is awaiting payment either from a manual invoice, or an auto-invoice that closes at the end of a time window (e.g. 1 hour). See steps 650 and 610 in Flowchart 100.

Pending recipient email: Payment has been received for an order that is e-delivered to an email address and the CP is waiting for the recipient to supply their email address.

Pending recipient address: Payment has been received for an order that requires a physical address but the recipient has not entered their physical address yet. See steps 810 and 820 in Flowchart 100.

Invoice expired: The payment was never made for the invoice within the required amount of time. See steps 900, 100, 1100 in Flowchart 100.

Read to place: Payment has completed and all dependencies (e.g. address) are completed—ready for Operator attention to place the order.

Fulfillment in progress: An operator is placing the order.

Order completed: The order has been submitted. See step 1200 in Flowchart 100.

Canceled by requestor: The originator has canceled the order.

Zombie: The recipient never provided an address. See step 1900 in Flowchart 100.

Delivered: The order has been delivered. See step 1500 in Flowchart 100.

In one embodiment an event-driven system is used to maintain the state. For example, when a “webhook” notification is received by the CP from the payment vendor that payment has been made, the database is updated for the order that the payment has been made and the next logical is invoked based on the relevant ancillary states. For example, if payment has been received, the CP must check if the recipient address is available. If not, the recipient is contacted and the status set to “Pending recipient address”. If the address is available, the status is set to “Ready to place” and the Operator is contacted. Instead of webhooks, polling of various services is implemented in another embodiment.

The following steps in the workflow occur.
If submitted, state moves to assigned when an Operator is analyzing the order.
Assigned can move to Unachievable or to Pending Payment.
Pending Payment can move to Pending Recipient Email or Pending Recipient Address.
Pending Recipient Email or Pending Recipient Address can move to Expired or Ready to place order.
Ready to place order can move to Fulfillment in Progress.
Fulfillment in progress can move to Order completed.
Order completed can move to Delivered.
Canceled by requestor can occur in any state prior to “Order completed.”

Various embodiments may include different commands to perform a variety of operations. The following sections describe several embodiments.

In one aspect in one embodiment there is a special provision in the workflow for automated “custom” items (items use uploaded user content from the CS to be printed on hats, shirts, mousepads, etc.). In this workflow the element of a mockup approval may be required. If so, the workflow is modified in the following way:
1) Order submission
2) Automated order approval
3) Notification to sender that mockup is available
4) If invoice is paid, mockup is considered approved and the normal workflow continues;
5) If the invoice is autopay and is paid, mockup is considered approved and the normal workflow continues;
6) If the invoice is not paid and the order not canceled, the order expires within the configured amount of time.
7) If the order is cancelled when autopay is on, then invoice must be voided.

In one embodiment a valid command is to find something on the Internet that meets the description and price range (e.g. “buy a wilson t2000 tennis racket for under $200 and ship to bob smith”). See the description of the CO below for details on this command.

In one embodiment a valid command is to assemble uploaded images into the CS into a video montage with audio track and optional subtitles.

The implementation of this requires several steps. First the user must be presented with a list of files that have been uploaded to the CS. This list can either be all files they have access to or just files they have uploaded, in another embodiment. The CP retrieves this from the CS and presents to the user either through a UI dialog box or a command line output. The user then selects the series of files from the list to be used from the montage. In another embodiment a list of MP3 (audio) files can also be included to allow the user to use a specified MP3 file as a background audio track. The order of the files in the list is the order in which the resulting image files will be rendered into the video montage.

In one embodiment the user is presented with an option to specify the delay between images in the montage.

In one embodiment the user is presented an option to specify a title page for the montage and what the title text should be.

In one embodiment the user is allowed to specify filenames with certain formats to include a subtitle to be included on the image during the rendering process.

Once completing the required and optional information either through a dialog box or iterative commands (or other UI elements) the processing of rendering the images begins in the background. The images must be resized so as to be uniform for the purpose of create a video. A title page may be constructed with the title information and any other relevant data (“author”, date, etc.). If an MP3 audio track was not supplied, one embodiment may choose a random background track or no audio track at all. When the conversion of single images to a video with audio track is complete, the user is notified after the file has been uploaded by the CP. Anyone skilled in the art of image processing and video file formats can easily combine single images into a video with an optional audio track, and hence the details of that process are not described here.

Autopayment

In another embodiment a valid command is to set or unset an autopayment mechanism that eliminates the need to enter credit card payment information for each order.

Most 3rd party billing systems implement individual invoices or optional auto-paid invoices. In one embodiment the user is given the option to opt-in to the autopay facility to avoid having to enter credit card information each time. The user's preference is stored in a persistent user database. They are allowed a command to disable to enable autopay at any time.

To avoid a nefarious user using their device when it is unattended, one embodiment can implement an optional “autopay password” that is required for each order when autopay is enabled. This password is stored in a cryptographically secure fashion and can be removed by the user if required. In one embodiment an email is sent (or text message) to the user if the autopay setting or password is changed, to detect yet another nefarious scenario.

Repetitive Orders

In another embodiment a valid command extension (that can be applied to most other orders) is to automatically recreate the order every day, N days, week, N weeks, month, N months, year, N years, every specific date, every holiday, every birthday, etc.

In one embodiment, a mapping table (or algorithm) allows the user of “2 weeks” or “two weeks” or “every other week” to accommodate the various formats a user might enter.

In one embodiment, the repeating frequency is stored in the order record along with a last ordered date which can be used to calculate the next future scheduled date. Each time the order is completed, a new “requested date” is constructed N days away from the then-current day based on the desired frequency.

If a repeating order is canceled then all futures are canceled.

Canceling Orders

In another embodiment a valid command is to cancel an existing order.

Cancellation is not as simple as might seem. If an order is in the Submitted state, it can be canceled. If it is in the Fulfillment in progress or completed state it cannot be canceled. If it has not been paid for it may be canceled but if the autopay was on and an invoice is outstanding the invoice must be voided. If autopay was or off or on and the invoice has been paid but the order has not been completed then a refund can be issued when the order is canceled.

Custom Orders

In another embodiment a valid command is to request an uploaded image into the CS be printed on a t-shirt, mug, mousepad, cap, etc. In one embodiment this is a completely automated task or could be done with a concierge.

The user is presented with a style of the item, either through a GUI element or iterative command line. A series of options is then presented (e.g. color of shirt, size of shirt, etc.).

The user is provided a list of files they have access to which may be used to print on the item. In one embodiment the file types are automatically filtered for only relevant image files (e.g. JPEG or PNG).

The user is then presented with a list of users to whom the shirt can be sent, within the team. In yet another embodiment an input field is provided for the user to enter the name and/or address of an external user who is not in the CS system.

Once the required information is provided, software Application Programming Interfaces are used to automate the placing of an order with an existing factory that can create the custom item with the digital. In another embodiment, the process is done “manually” by an operator placing the order to the factory. In one embodiment a mockup of the final is provided for the originator.

Specific Date Requests

In another embodiment a valid command can be placing an order on a specific date, e.g., birthday, month/day/year, holiday. Error validation must occur to make sure the date is not in the past and that the entered value is valid. If a date is provided without a year, it is assumed to be in the subsequent year. Mnemonic may be used and looked up in mapping table for holidays. If the token “birthday” is supplied then it is assumed to be the birthday of the recipient.

In one embodiment the implementation uses an item in the order record of an “ondate” for which the item is intended to be scheduled.

In one embodiment the “ondate” is intended to be the delivery date in which a “buffer” must be factored in before when it is processed. In another embodiment the “ondate” refers to the date on which the order should be processed.

Checking Order Status

In another embodiment a valid command is to check on order status. Order status contains a report of both orders for which the user is the requester and the recipient. In one embodiment the format of the output must be tailored in a way appropriate to the device. For example, a user on a mobile device will not want to view a large complex report with many wide columns. In one embodiment the user can issue an option on the command to indicate what report format they want (e.g. “wide” or “short” or “brief” or “long”) and optionally how many N most recent records they want to view, e.g. “last 5” or search terms “for john” or “to me”. In another embodiment the CP can detect the type and size (display) of the user device and choose the optimal display format.

All orders are stored in a persistent database where standard queries can be used to derive the required information and be formatted by the CP.

Specifying Physical Address for Delivery

In another embodiment a valid command allows specifying a specific physical address for delivery. NLP or simplistic parsing can be used to detect the clause where the address is specified. In one embodiment, the address is parsed for validation and errors are reported if there is a failure. In one embodiment, the address is normalized to a conventional format either with custom algorithms or using 3rd party address normalization processes. Addresses may be validated as actual addresses that can be delivered via a postal service, in yet another embodiment.

If an address is specified it is assumed that the recipient is not within the CS team (though they could be) hence no name validation against the list of members is performed. Instead this order is flagged in the order record as having a specified physical address. The workflow in this case is modified such that email notification and “Direct Messages” (“DM”) in the CS are not used to convey status information or delivery notification or tracking numbers. Also, the workflow milestones are adjusted to avoid having to wait for recipient address since it is provided at the time of order submission.

Multiple Recipients

In another embodiment a valid command allows specifying multiple recipients in a single command. NLP parsing or simplistic parsing can both be used to detect that the order is to have a single request (with one or multiple items) be sent to a list of recipients.

In one embodiment the implementation of this scenario requires the creation of N orders for N recipients—one order for each recipient with duplicated items-to-be-ordered and the same price limit. This allows for the case that one recipient does not supply their address but the remaining recipients do, and thus it is not an “all or none” scenario, meaning one order can fail and the remaining ones can succeed.

In this scenario the specification of a physical address must be eliminated.

In another embodiment a valid command allow specifying recipients within the CS without the need to specify their address and asynchronously requests the addresses from the recipients.

Setting a Birthday

In another embodiment a valid command allows a CS team member to set their birthday so that other users may send them something on their “birthday.”

It may be convenient and desired for a user to want to send something to a CS member on their birthday, without knowing the recipient's birthday. This is accomplished by allowing all team members to update “profile” information, one property of which can be a “birthday.” Once the birthday is set with the appropriate command, the value supplied by the user is stored in a user profile record. In one embodiment this value is not shown to other users but can be used in expressions such as “order one dozen roses for jane doe on her birthday” or “order a dozen roses for jane doe by her birthday”. In this case the CP checks to see if jane doe has provided their birthday. If the birthday is not provided various things can occur.

In one embodiment, jane doe is sent a DM asking for her birthday, in the context that someone wants to send something to her on her birthday. She responds either through a command interface or other UI element, the data is stored in her profile record, and the order is then processed. Ultimately, after some configured period of time, if jane doe does not supply her birthday, an error occurs, the order is canceled and the requestor is notified.

In another embodiment, the requesting user is informed that jane doe does not have a birthday configured and is told to ask jane doe to update her birthday.

Once the birthday for jane doe is provided, either previously or otherwise, the order can be completed with a processing date on or before her birthday. In one embodiment there is a “slop time” buffer that is configured such that an Operator will have sufficient time to order the desired item for the recipient and have it arrive in time for the recipient's birthday.

In one embodiment, if there is insufficient time to procure the item by the birthday the order is canceled.

In another embodiment, if there is insufficient time to procure the item in time, the requestor is prompted to accept the condition or cancel.

Recipient Shipping Address

In another embodiment a valid command allows a user to specify their destination shipping address to be used for any items ordered for them. If the desired item ordered is not delivered via email, then a physical address must be provided at some point in the workflow so that the order can be placed by the CO.

If the physical address is not provided, a background task must run (see Flowchart 500) to detect an expiration time window before the order is canceled. In one embodiment the recipient is given a warning within a configurable window of time to encourage them to respond. If they don't respond in time the order is canceled. If the order has been in a paid state, the originator must be issued a refund.

The physical address must be parsed at some point to verify validity. Both syntactic validity and address validity (the address actually exists) can be done with 3rd party services that perform address normalization. This dramatically reduces the likelihood of errors. In one embodiment this validation is performed by custom algorithms.

In one embodiment the recipient, and any user, is provided a command to set their address at any time. Similarly, an analogous command exists to set their name to be used for a shipping label, since their name in the CS may not be a “real” name to use for shipping address purposes.

In another embodiment a valid recipient can be the originator by using the term “me” or “myself” or something similar.

There is nothing to preclude the originator and the recipient to be the same user and hence send to themselves. In one embodiment, this is done by comparing the CS user id of the originator to the CS user id of the recipient. If they are the same, the order is considered to be for “self” and flagged appropriately in the order record. In this case several things can occur.

In one embodiment, all DM to the user and emails about the order have different wording that reflect the cognizance of the CP that the order is for the same person. Instead of referring to “Your order to jane doe is complete” the messaging is modified to say “Your order to yourself is complete.”

In one embodiment, the term “me” is allowed in the command syntax to encourage users to place orders for themselves. For example, in one embodiment, the phase “send one dozen viva paper towels to me” is considered valid, with NLP or simplistic parsing detecting that “me” means the user issuing the request.

Item Browsing

In another embodiment a single command may bring up a series of products/items/services that can be purchased and may be done with assistance of a graphical user interface component or iterative command-line based responses.

Instead of a user specifying a product description, barcode, or other identifying information for the product to be ordered, another completely different user experience is the ability to “browse”.

The browse ability can be implemented either via graphical user elements (if the CS supports the feature) or simply via command line responses.

The initial request is parsed and detected as a desire to browse products. In one embodiment the phrase “browse jewelry products” indicates the browsing products is desired, within the jewelry subcategory. In one embodiment multiple categories are supported, along with a search ability.

The user is presented a finite subset of items either with the GUI or command line output. The user then has the option to paginate “more” or “next” in the GUI or type “browse more” or “see next” or similar expressions to indicate to see more pagination results from the larger result set. In this case, additional items are presented.

At some point the user may see items they are interested in purchasing. In one embodiment they may type “buy item <number>” when then simulates the “submitted” order state normally initiated with the CO-handled events or the automated flows. In one embodiment, the CP emits back the command that would have normally been typed to create such an event.

The browsed list can be manually curated or, in another embodiment, be automatically populated via various sophisticated pricing and acquisition rules and business relationships. Sponsorships can be provided such that certain advertisers can have their products placed for a fee or in another embodiment as part of a revenue-sharing system based on sales or other fees.

Once the item is selected, the same information is gathered either through GUI or iterative commands for recipient, destination address, frequency/repetition, “on date”, etc. The browse scenario, in one embodiment has a fixed price that eliminates the need for the originator to specify a maximum price.

Non Physical Goods

In another embodiment, products with digital delivery (email, SMS, etc) are offered as options. It is becoming increasingly popular to purchase digital content, whether it be sheet music or e-Gift cards. In these cases, there is no physical address required for delivery, but an email address or phone number or other analogous form of electronic delivery destination is required.

If a request (coming from browsing items or natively entered order) is flagged for e-delivery, then the milestone of obtaining a physical address is eliminated. Also, a physical address cannot be specified for e-delivery items (that would be an error condition). However, the physical address milestone is changed to be an email address milestone. In one embodiment, the email address is automatically extracted for the recipient user from the CS database via the CS API that allows queries for user profile information.

Gift Messages

In one embodiment, the originator has the ability to specify a note or gift card message that appears as a separate note or on the packing slip (or email in the case of email delivery of digital goods). An individual command is provided for this and when invoked by the originator, the state of the order must be verified to determine if it is “too late” for the gift card message to be applied. Once the order has been place by the CO or the automated fulfillment system, the originator must be informed that their request cannot be processed. If it is not too late, the CO can enter the information when placing the order. In the case of a fully automated order, an API is used to set the “then current” gift card message if the fulfillment vendor supports such a facility.

In the case of Concierge orders, they are processed by Concierge Operators (CO). The CO is notified that an originator needs attention per earlier discussion. The notification can take many forms as outlined. There are many conditions that require CO to take action. See Flowchart 600.

In one embodiment a new order submitted that has been parsed and validated as acceptable triggers an event for CO notification.

In one embodiment a completed payment and address condition triggers CO notification that an order can be placed on behalf of the requestor.

In one embodiment a response from an originator to a question from the CO triggers a CO notification.

In the case of notification upon order submission, the CO must verify that the request can be satisfied. This entails verifying such a request can be found (e.g. a “Original Mona Lisa” may prove elusive, but a “can of Wilson tennis balls” would be obtainable). Secondly, if there is a price constraint on the request the CO must verify that a product exists that matches the description and price, optionally factoring in tax, shipping and handling or transaction fees.

If the order is not achievable, the CO must indicate via the Operator Interface (OI) that it is not achieve. The OI is then responsible for contacting the originating user to inform them the order is canceled and is unachievable. The OI uses the RM to communicate with the user.

Before a CO can approve the request/order, in one embodiment, the OI verifies that the CO has entered a URL or other reference information to verify such an entity exists. Also, in one embodiment, the OI makes sure that the CO has entered the price, estimated tax and shipping, and adds those values along with any relevant commissions and transaction fees (handling charges) and verifies the total amount is less than any specified maximum cost.

Once the OI completes the order approval process, an invoice is sent or, an auto-billed invoice is created that completes without originator involvement. In another embodiment there is no pending for payment, albeit this is a more risk approach as the originator may not end up paying the invoice. Hence, in the default scenario the status is now pending payment.

An asynchronous process runs (see Flowchart 500) on a specific frequency (e.g. 1 minute) using various “CRON” type facilities on most computer systems. This process runs and checks if an order never reaches its required dependencies such as payment (within in a period of time) or email or physical address information requirement for shipment delivery.

There is no OI or CO involvement until the dependencies are achieved and expiration for either does not require OI or CO involvement as it can be completed automated.

In one embodiment, instead of payment being required for address existence checks complete, the address existence check is done in parallel while awaiting payment. While this can speed up the process, it risks upsetting the recipient who supplies their address and then ultimately never receives anything because the originator never completed payment.

Once the dependencies are completed, the OI notifies the CO that the order is “ready to place.” In this case, the same, or different CO (compared to who first responded when “submitted”) uses the previously entered URL information to place the order on behalf of the user originator. In the event of a dramatic price change in the interim, the CO can use the OI to request clarification that the change is OK and set the status to “Pending Response.” Assuming this is not the case, the CO can place the order using the recipients shipping address. In one embodiment if the originator specified a gift card message, this can be specified at the time of ordering.

When the order is placed the remote order ID from the e-commerce site used is stored within the order record by the CO entering it into the OI. At this point an asynchronous process may be initiated to check for order status so as to update the order record with delivery status or tracking notifications. In another embodiment, this is done when a file is uploaded by the CO with batch-downloaded order status. In another embodiment this is not done by polling (asynchronous process) but by a “webhook” that makes an HTTP request to the CP indicate a status change with a given order.

At this point the CO marks the order complete within the OI and the OI uses the RM to update the originator and recipient (where relevant, i.e. a recipient with a specified physical address who is not with the user community of the CS will not get a notification unless an email address or phone number is provided for an email update or text message (sms) notification.

I claim:

1. A method comprising:
establishing, by use of a data processor, a data connection and session with a chat/collaboration system;
receiving, by use of the data processor, a request from a user to initiate an e-commerce transaction within the chat/collaboration system session;
parsing and validating, by use of the data processor, tokens of the request;
generating, by use of the data processor, an order from the validated tokens;
determining, by use of the data processor, if the order is for an automated item or a concierge item; and
submitting, by use of the data processor, the order for processing.

2. The method of claim 1 including assigning the order to an operator if the order is a concierge item.

3. The method of claim 1 including automatically submitting the order if the order is an automated item.

4. The method of claim 1 including using an application programming interface of the chat/collaboration system to automatically obtain user information.

5. The method of claim 1 wherein the e-commerce transaction is for a digital service.

6. The method of claim 1 including validating tokens of the request based on a list of users associated with the chat/collaboration system.

7. The method of claim 1 including using user interface (UI) elements of the chat/collaboration system to interact with the user.

8. The method of claim 1 including using the chat/collaboration system to automatically obtain user credit card information.

9. The method of claim 1 including tracking the user's payment for the e-commerce transaction and sending a notification to the user if payment is past due.

10. The method of claim 1 including tracking fulfillment of the e-commerce transaction and sending a notification to the user upon fulfillment of the e-commerce transaction.

11. A system comprising:
a data processor; and
a control program executable by the data processor and in data connection and session with a chat/collaboration system via a data network, the control program configured to;
receive a request from a user to initiate an e-commerce transaction within the chat/collaboration system session;
parse and validate tokens of the request;
generate an order from the validated tokens;
determine if the order is for an automated item or a concierge item; and
submit the order for processing.

12. The system of claim 11, wherein the control program being further configured to assign the order to an operator if the order is a concierge item.

13. The system of claim 11, wherein the control program being further configured to automatically submit the order if the order is an automated item.

14. The system of claim 11, wherein the control program being further configured to use an application programming interface of the chat/collaboration system to automatically obtain user information.

15. The system of claim 11 wherein the e-commerce transaction is for a digital service.

16. The system of claim 11, wherein the control program being further configured to validate tokens of the request based on a list of users associated with the chat/collaboration system.

17. The system of claim 11, wherein the control program being further configured to use user interface (UI) elements of the chat/collaboration system to interact with the user.

18. The system of claim 11, wherein the control program being further configured to use the chat/collaboration system to automatically obtain user credit card information.

19. The system of claim 11, wherein the control program being further configured to track the user's payment for the e-commerce transaction and send a notification to the user if payment is past due.

20. The system of claim 11, wherein the control program being further configured to track fulfillment of the e-commerce transaction and send a notification to the user upon fulfillment of the e-commerce transaction.
